(19) United States
(12) Patent Application Publication
(10) Pub. No.: US 2015/0310499 A1
(43) Pub. Date: Oct. 29, 2015

(54) DIGITAL-MEDIA ADVERTISING OPTIMIZATION PLATFORM

(71) Applicant: RED FOX MEDIA LTD., London (GB)

(72) Inventor: Marcus Jonathan BROOK, Midlothian (UK)

(21) Appl. No.: 14/700,467

(22) Filed: Apr. 30, 2015

Related U.S. Application Data
(63) Continuation of application No. 13/924,673, filed on Jun. 24, 2013, now abandoned.
(60) Provisional application No. 61/663,202, filed on Jun. 22, 2012.
(60) Provisional application No. 61/838,374, filed on Jun. 24, 2013.

(51) Int. Cl. G06Q 30/02

(52) U.S. Cl. CPC G06Q 30/0269

(57) ABSTRACT

This invention provides a model and architecture that allows databases from diverse advertisers/brands and databases from diverse digital content providers to be virtually intertwined without compromising privacy and without actually comingling any of information any the databases. A trusted third party establishes relationships with advertisers/brands on the one hand and digital content providers on the other hand. If desired, additional demographic information about individuals who have established relationships with the advertisers/brands and the digital content providers may also be utilized to further target the advertising. As described in more detail below and in connection with the drawings and attachments hereto, using the method and architecture of the present invention, advertising can be targeted precisely and in accordance with strategic concerns, rather than using a best estimate as to the optimality of the advertising based on the opinions and gut-instincts of an advertising executive or advertising campaign management-team.

### CROSS-REFERENCE TO RELATED APPLICATIONS

This application is a continuation of U.S. application Ser. No. 13/924,673, filed on Jun. 24, 2013, which claims priority to U.S. provisional Application No. 61/663,202, filed Jun. 22, 2012, and U.S. provisional Application No. 61/838,374, filed Jun. 24, 2013, the entire contents of each of which is incorporated fully herein by reference.

### FIELD OF THE INVENTION

This invention is related to the field of targeted advertising and, more particularly, to targeted advertising provided in connection with digital content.

### BACKGROUND OF THE INVENTION

More and more people are turning to digital sources for information. E-readers such as the Kindle® and the Nook® provide readers with practically instantaneous electronic access to magazines, books and other digital content. Tablets such as the iPad® provide similar access to reading materials as well as complete access to the Internet and other network connections. Laptop computers, desktop computers, PDA's, mobile phones, and smartphones also provide this capability.

Part and parcel of this pervasive connectivity is advertising. Once the Internet became more user-friendly and became the primary means worldwide for providing access to digital information, advertising on the Internet and other public connectivity portals followed close behind. Estimates for 2012 indicate that advertisers will spend approximately $100 Billion in online advertising.

Online advertising takes many forms, from emails (solicited or unsolicited) to banner advertisements on webpages to more targeted advertising based on previous purchases made or the location of the device being used to view electronic content. Some techniques are more effective and/or cost-efficient than others, and advertisers are constantly seeking to develop new advertising models to increase the effectiveness and efficiency of the advertising.

As an example, most smartphones today include GPS capability that allows a user of the smartphone to identify their location at any given time. If the user establishes settings for the smartphone that enable third parties to access this location information, a visit to a website from that smartphone can deliver the requested content to the user along with location-based advertising. For example, a user of a smartphone standing on a street-corner in Philadelphia who accesses a search engine such a Google may be served advertisements for a local Philadelphia bakery, car dealer, or nightclub.

Another method of providing more focused advertising is to use historical information about previous activities of a particular user. If information about previous purchases is available, the user may be served advertising or “suggestions” based in their prior purchase history. For example, if a user logs into their Amazon.com account they will be shown “Featured Recommendations” which identify products available for purchase on Amazon.com that are considered similar to previous purchases made by the same user.

While these techniques may provide more effective advertising than a complete “shotgun” approach, whereby advertising is served to viewers of digital content essentially at random, they are still quite limited in terms of effectiveness. In the location-based example above, while the location of the user is relevant, the user may be a person with no interest in baked goods, cars, or nightclubs. In the historical approach described above, the advertising is limited to offerings of the website being accessed (e.g., Amazon.com will only provide recommendations for goods available for purchase on Amazon.com).

It would be desirable to be able to provide focused advertising that is always directed to the specific interests of a particular person viewing digital content, and preferably delivered in “real time” to provide not only advertising targeted to that person, but also targeted to a particular time and date. The present invention provides this functionality and more.

### SUMMARY OF THE INVENTION

This invention provides a model and architecture that allows databases from diverse advertisers/brands and databases from diverse digital content providers to be virtually intertwined without compromising privacy and without actually comingling any of information any the databases. A trusted third party establishes relationships with advertisers/brands on the one hand and digital content providers on the other hand. If desired, additional demographic information about individuals who have established relationships with the advertisers/brands and the digital content providers may also be utilized to further target the advertising. As described in more detail below and in connection with the drawings and attachments hereto, using the method and architecture of the present invention, advertising can be targeted precisely and in accordance with strategic concerns, rather than using a best estimate as to the optimality of the advertising based on the opinions and gut-instincts of an advertising executive or advertising campaign management-team.

### DESCRIPTION OF THE DRAWINGS

FIG. 1 is a block diagram illustrating the basic architecture of a system according to an embodiment of the present invention;

FIG. 2 illustrates the various processes and steps performed in connection with the claimed invention

FIGS. 3-6 are PowerPoint slides illustrating various aspects of the prior art (FIG. 3) and the present invention (FIGS. 4-6).

### DETAILED DESCRIPTION

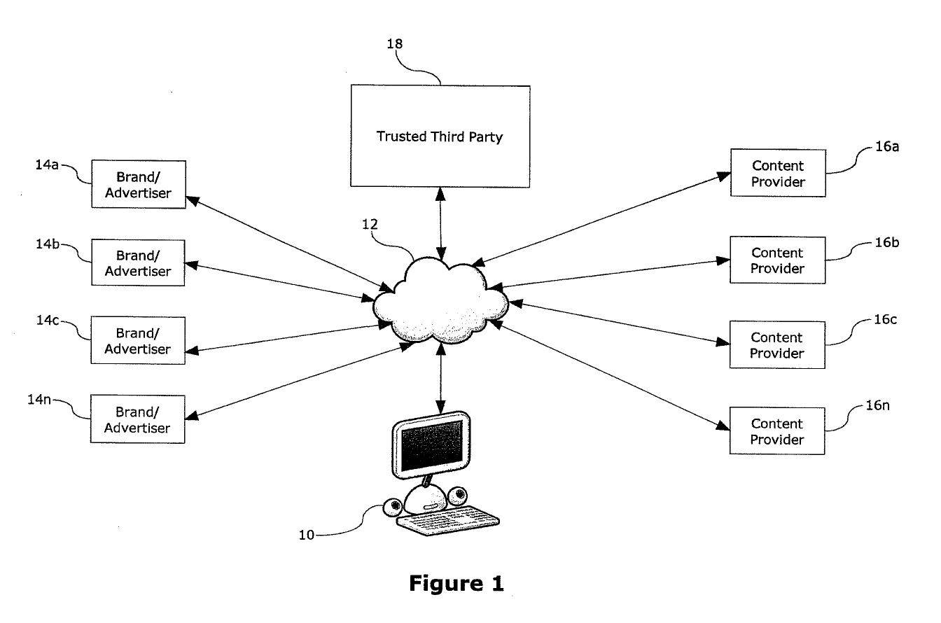

FIG. 1 is a block diagram illustrating the basic architecture of a system according to an embodiment of the present invention. Referring to FIG. 1, a user of a device for accessing digital content is represented by a workstation 10. It is understood that the manner in which a user may access digital content will vary and workstation 10 can include, but it not limited to, a desktop computer, a laptop computer, a tablet device, a smartphone, a mobile phone, a personal digital assistant, or the like.

Workstation 10 is coupled to a network 12, e.g., the Internet, in a well-known manner, which can include a hard-wired connection, a modem connection, a wireless connection, etc. As is well known, a user of the workstation 10 may connect to various sites 14a-14n that are run or sponsored by companies and which are related to a particular brand of goods or services. For example, site 14a might be a site associated with they XYZ car company, and a user of the workstation 10 may be registered with that site because they own an XYZ car. Perhaps the user of workstation 10 accesses site 14a to buy accessories, track the maintenance schedule for the car, receive notice of recall, etc.

Site 14b might be a website form which the same user of workstation 10 purchases wine. The user has registered with site 14b and receives emails and other forms of advertising from site 14b about wine. As can be understood, each of the sites 14 that the user interacts and registers with are different and the types of goods and services that they are associated with is unlimited.

The user of workstation 1 may also subscribe to various sources of digital content, such as newspapers, magazines, blogs, and the like. These content providers are represented in FIG. 1 by content providers 16a-16n. For example, content provider 16a can be the New York Times, and content provider 16b could be The Scotsman, a daily newspaper originating in Scotland. In a known manner, the user of workstation 10 subscribes to content provided by the content providers 16, either for pay or for free, and once subscribed, the content can be pushed to the user or pulled by the user of viewing on the workstation 10.

Finally, a trusted third party 18 is also connectable to the workstation 10, the sites 14, and the content prodders 16 via the network 12. The Trusted Third Party 18 facilitates the processes provided by the present invention, as more fully described below.

The operation of the various elements described in FIG. 1 is as follows. Each of the sites 14 “knows” something about the user of the workstation 10 because the user is registered with the sites 14 in order to have access to their offerings. For example the XYZ Car Company may know the users name, home address, work address, occupation, the kind of car he/she drives, the maintenance schedule for that car, the warrant information of that car, the accessories that came with the car when it was purchased. In this example, suppose a service interval is coming up for the car in 2 weeks.

The content providers 16 know information about the user as well. In particular, they know precisely when the user logs on to read content, since the user must sign in to read the content in a known manner. Most likely they have also gathered demographic data about the user as part of the registration process.

The Trusted Third Party establishes relationships with each of the sites 14 and content providers 16. The relationships are “closed” relationships, that is, none of the data of any of the sites 14 and any of the content providers 16 is shared. However, given the relationship of each of the sites 14 and content provider 16 with the Trusted Third Party 18, the Trusted Third Party can essentially “direct” the flow of advertising traffic to individuals, in a precise and targeted manner. For example, the Trusted Third Party can cause an advertisement to appear on the opening page of the user's digital subscription to the New York Times when the user accesses it with 2 weeks to go until the service interval on the XYX car owned by the user. It can provide a reminder, it can provide a coupon for a discount on the service interval if it is taken to the deal in the next day, etc. The point is that the Trusted Third Party 18 establishes relationships with brand providers/advertisers on the one hand and content providers on the other, and working with each can provide targeted pinpoint advertising or other information to users via their digital content subscriptions.

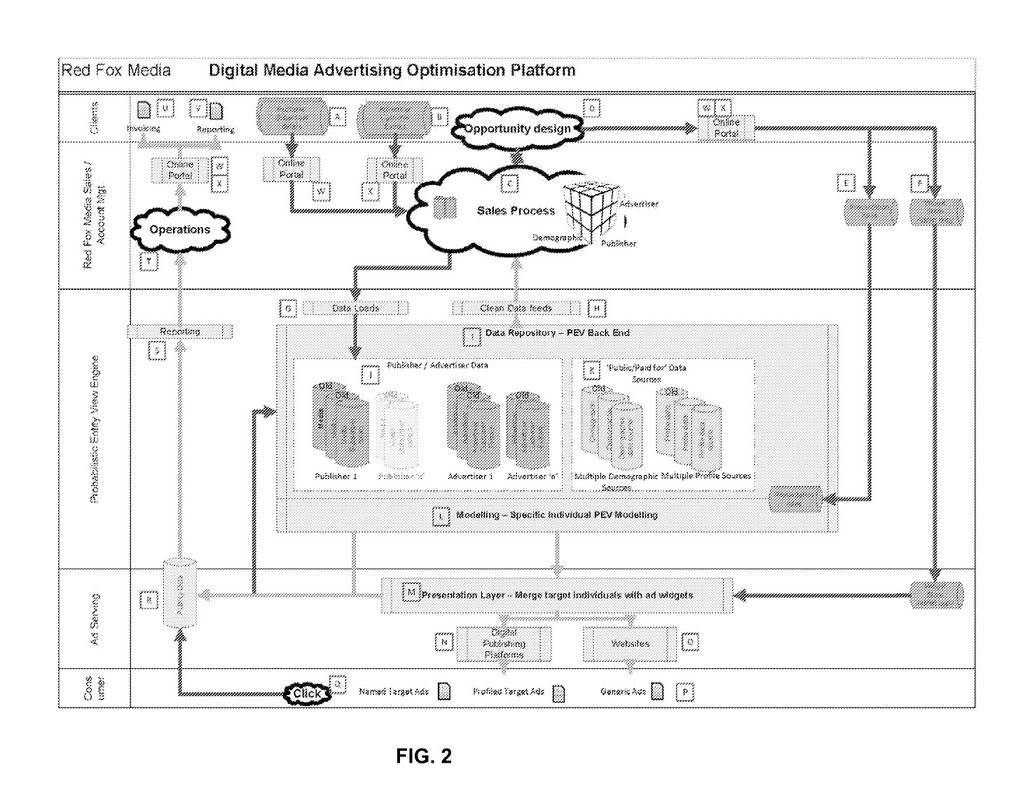

FIG. 2 illustrates the various processes and steps performed in connection with the claimed invention. The following notes and definitions support the description of these steps, which description follows the notes and definitions.

The Digital-Media Advertising Optimization Platform is referred to herein as AdOpt. AdOpt enables advertising and customer service propositions to be served to individual subscribed consumers of digital media. AdOpt fuses data from different companies (advertisers and publishers) with background information (direct marketing databases) to provide a uniquely rich and sophisticated take on ad selection and placement.

AdOpt lets advertisers create rule-based campaigns to target: precise demographic segments e.g. young female home-owners with children; existing customers with known properties e.g. John Doe whose car insurance needs to be renewed next week.

The data is structured & stored so that the separate data sources are kept secure, and neither customer privacy nor commercial advantage are ever compromised. The AdOpt model allows databases from diverse advertisers and publishers to be fused together without compromising privacy. Building on this enriched database, data modelling automatically scores any individual's circumstances vis a vis their demand for an advertiser's offer.

AdOpt integrates with existing digital media industry ad servers and enables a large subscriber base to be accessed. The system serves advertising widgets in significantly less than 1 second, no matter where the customer is accessing the media and from what device.

Ads can be targeted precisely and in accordance with strategic concerns, rather than someone else's idea of optimality. This is in stark contrast to the black box provided by others in the prior art. AdOpt also allows both publishers and advertisers to release the value that is currently locked away in their subscriber and customer databases. This is not possible with existing systems.

Finally, AdOpt is a brokering service between elites. It's about quality, not quantity. Quality screen-estate, meeting quality targeted advertising. All of this adds up to a new approach to on-line advertising that is more flexible, more cost-effective and more empowering, than existing models.

What follows is a description of the platform of, and processes and steps performed by, the claimed invention. Uppercase letters below reference directly to the same letters in FIG. 2.

A—Publisher Subscriber Details

The details of individual subscribers, who have not opted out (or have opted in), to being used for profiling and being contacted with targeted materials. This data is provided via an online portal (Ref W) to allow initial opportunity design (Ref D) and then on a frequent basis (Ref G) to allow targeted content to be served.

B—Advertiser Customer Details

The details of advertiser customers, who have not opted out (or have opted in), to being used for profiling and being contacted with targeted materials. This data is provided via an online portal (Ref X) to allow initial opportunity design (Ref D) and then on a frequent basis (Ref G) to allow targeted content to be served. The data provided includes transactional details (such as purchases made or services used), as well as generic customer details.

C—Sales Process

This takes extracts of subscriber data (Ref A and J), Advertiser data (Ref B and J) and Profiling Data (Ref K) via the data feed (Ref H) and uses the data to work with Publishers and Advertisers to identify subscriber and customer profiling opportunities to serve targeted content. The data is analysed in three dimensions, plus using decision trees, to identify campaign opportunities (Ref D).

D—Opportunity Design

Publishers and advertisers have access to an online portal (Ref W and X) that allows them to set the Presentation rules (Ref E) to be used to select specific targeted subscribers and advertiser customers. The rules are be defined in a specific format to be used by the PEV Modelling (Ref L). Once the Presentation Rules have been defined the Advertisers design and load their advertising widget into the Widget Store (Ref F) for use in the presentation of the advert to the reader (Ref M).

E—Presentation Rules

Two sets of rules are established via an online portal:

First: A set of rules for advertisers that defines the characteristics of an advertising campaign, loaded via an online portal (Ref X). Rule data includes the campaign window, the profile of the individuals to be matched to receive the campaign, the reference to the advertising widget to be used and any exclusion key word tags to be used to avoid publishing the ad in inappropriate publications, pages within publications or websites. In addition to the definition of what widget to serve when there is a profile match there will also be associated rules to define the action to be taken where there is no match, for example server generic advert.

Example: If Sex=female and (num_children>1) and location=Edinburgh then cardvertiser1_suv_campaign_edin

Each advertiser defines multiple rules that are attached to an advertising promotion. Rules link a set of field values with an ad e.g.

IF sex=female & carcompany.subscriber=true & carcompany.last_model=SUV THEN spring-2012-offer@carcompany

Each rule is associated with a bid price—how much the advertiser is prepared to pay for the sort of person identified by the left hand side of the rule. A charge will be applied at that price times the % confidence that an individual falls into that group. (Ref L)

Advertising clients can construct rules which link defined segments to (sets of) adverts.

e.g. IF sex=female and (num_children>1) and location=edinburgh THEN carcompany_suv_campaign_edinburgh

This would be an extremely specialised advertising campaign but it could arise from an advert designed for mothers, with the text tweaked for multiple children, and an Edinburgh-specific call-to-action.

IF sex=female THEN carcompany_female_campaign2

Advertisers also associate a “bid price” with each rule. This corresponds to the amount they're prepared to pay to show an advert (specified on the right-hand side of a rule) to a given demographic group (specified on the left-hand side).

In a traditional SRV context, the interpretation of these rules is clear—they either apply or they don't. The PEV, however thinks in terms of a firing strength. The idea is to preserve the notion that an advertiser is willing to pay £X for access to a member of a specified group. So, if we're 90% sure that an individual is female, 50% sure that they have more than 1 child and 100% sure that they're in Edinburgh, then the first of the above rules fires with strength 45%. If this advert is shown to 100 people, it will reach 45 who exactly fit the specification.

Multiplying the firing strength by the bid price gives the fair price to charge to an advertiser, such that they get what they paid for (e.g. the advert is shown to 45 Edinburgh women with 2+children)—plus some extra (the advert is shown to some people who don't fit the target profile). The system then picks one of the higher priced rules and shows the corresponding advert.

Some rules may reference pay-for datasets e.g. “data8.suppression” Firing such a rule costs money. This sets a minimum price/confidence threshold for the rule. This logic is executed in the Modelling Layer (Ref L).

Second: A set of rules for the publishers, loaded via an online portal (Ref W) to allow them to define exclusion key words to prevent inappropriate advertising content in publications, pages within publications or websites.

F—Widget Store Advert Content

Via an online self-serve portal (Ref X) the advertisers load up the ‘copy’ (called a widget) of the advertisements to be placed associated with a specific campaign. Each ad will have a unique identifier. This is a combination of the advertiser reference (from Data Input slug) and an ad reference. The structure of the ad itself contains key data fields for presentation based on individual profiling from the Presentation Layer (Ref M). The fields are for items such as name substitution plus message substitution. There can be a restricted number of these variables available over all ads. The ad templates also have data to record when it was presented to the publication (date, time etc.)

No logic is inside the ad, they are treated as templates that are populated at the time of Presentation layer execution (Ref M). Note: Ad content is be provided as HTML templates. Advertisers can use Velocity template directives to incorporate data along “mail merge” lines e.g. “Hello John! Check out the latest Edinburgh deals on SUVs!”

G—Data Loads

On receipt of a data file from the online portal (Ref W and X) in a defined format it is reviewed and any problem data stripped out and reported on for manual correction, the balance of the file is extracted for loading into the Data Repository (Ref I). Supplementary files may be loaded once the client has corrected any problem data resolved.

A file of ‘slug names (1)’ used to be maintained to avoid duplication. A unique identifier will be given to every row on the table to be loaded, this will contain the slug and database version number. Each row will be for a specific subscriber or advertiser customer. The data loaded will consist of standard data items, such as email address and also publisher or advertiser specific fields, for example car model.

For the data received from the client and loaded up to a temporary staging area for the Data Repository an Activity Report (Ref R) is then created to provide feedback to the client on what has been loaded. This will be accessed via the online portal.

Each file being presented to the PEV is held is a ‘staging’ area that is then be pulled into the PEV data models at the appropriate point in the PEV cycle which can be on a timed frequency or as and when a new file is available to load.

Within the data load are both a ‘unique plugin’ and a ‘generic plugin’ available for each advertiser and publisher that will be used to format the imported data into a PEV compatible format (for example surname format).

Note. A similar set of plugins are used to load the ‘Public/Paid for’ Data Sources (Ref K).

(1) Slug: A definition of data which identifies the data by human-readable keywords, for example “Slug_customer_Reference_number rather than an opaque identifier such as the ID number of the content within the database (e.g. “27077911”). Slugs are used to construct clean reference that are easy to type, descriptive, and easy to remember.

H—Clean Data Feeds

Extracts of the data held on the Data Repository are provided into the Sales Process (Ref C). These are used to assist current publishers and advertisers in the identification of new campaigns and the analysis of existing campaigns.

I—Data Repository—PEV Back End

Databases from diverse advertisers and publishers are loaded into a virtual server array via the Data Load (Ref G) and referenced using the PEV data reference keys such that no historical data is ever overwritten or removed (Ref J). All data is immutable, once created it cannot be updated or deleted.

The Repository also holds and retains imported data from reference sources of publicly available and paid for data (Ref K) to provide supplementary profiling data. This data is also loaded on to a virtual server array.

All data is structured and stored so that the separate data sources are kept secure, and neither customer privacy nor commercial advantage are ever compromised. No data from one client will ever be visible to another and is maintained within separate databases. Publishers and Advertisers can only see data on people they have supplied, plus augmented demographic data, they cannot have access to any other data, directly or inferred, from any other sources.

J—Publisher/Advertiser Data

Data loaded up from the Data Load (Ref G), via the ‘plugin’ is deployed onto the virtual server arrays and added to the other data from the same source. Each data set is referenced using the assigned ‘slug’ references. This is the core subscriber and customer data from publishers and advertisers that has permissions from the individuals, for use in profiling and content serving. The data contains key data attributes that allows the PEV to carry out the modelling and mapping (Ref L) as well as data attributes that are specific to the advertiser or publisher.

The publishers and advertisers have one or more databases each depending on their publication and product segmentation. In setting out the data schemas for each publisher and advertiser they do not need to share a single ontology (database schema). The system can flexibly accommodate and make use of different taxonomies and representations.

Client data does not need to be infallible. Because the customer profiles are inherently probabilistic, contradictory information can be allowed for.

Client data does not need to be complete. Profile fields can be filled out on a best-guess basis e.g. inferring that a “Jane Smith” is 80% likely to be female.

The PEV contains one profile for each Client identifier. As the business scales this will rapidly exceed one billion rows.

The profiles contain a wide and growing variety of different information (from fusing in new data sources). A fixed set of fields is not sufficient.

The information contained within the profiles is inherently probabilistic.

The profiles must contain trace information to facilitate debugging, audit and data protection controls.

Each database may be enhanced with reference to any (all or none . . . ) of the other databases. This relationship is asymmetrical—so CarCompany might (by arrangement) use HolidayCompany data without exposing anything of their own. Statistics are then generated to report on the data loaded and written to file for reference (Ref R).

K—Public/Paid For Data Sources

Data loaded via the ‘plugin’ is deployed onto the virtual server arrays and added to the other data from the same source. Each data set is referenced using the assigned ‘slug’ references.

The source data sets contain demographic and profiling data that is available from public bodies or commercial sources. Where commercial data is sourced the use of the data is tracked to allow appropriate payments to be made to the provider. Statistics are then generated to report on the data loaded and written to file for reference (Ref R).

L—Modelling—Specific individual PEV Modelling

The Publisher/Advertiser Data (Ref J) is enriched with the Public/Paid For Data Sources (Ref K) and the Presentation rules (Ref E) are pulled in to allow the data modelling to automatically score any individual's circumstances vis a vis their demand for an advertiser's offer. This is achieved by fusing data pertaining to the Customer, from Publishers Subscriber databases, Client's customer transactional data sets and Third Party data such as direct marketing databases. Advanced data modelling techniques will constantly refine and remodel the data as a result of additional data being sourced.

Each individual loaded from a publisher or advertiser is assigned a unique identifier that is a combination of the customer and a number, e.g. individual is CarCompanyCustomer-12345. The same actual person could also be introduced by another publisher or advertiser and that occurrence of the person would have a separate number e.g. HolidayCustomer-98765.

In the PEV the two records are kept physically separate, however, they will be matched based on the data features of the records (e.g. post code and other fields). Based on a range of features matched records are created with a % probability applied to the certainty of the match. This probability can be used in the parameters of the advertisers presentation rules (Ref E) to select a match % threshold to be achieved for ads to be served. The match will also be against the data on individuals who have been pulled in from generic data sources e.g. ElectorialRolePerson-687676.

The output from this modelling will be to select the combination of Subscribers and Advertiser Customer who satisfy a set of advertising rules (Ref E) and feed that result out for presentation into the publication medium (Ref M).

M—Presentation Layer—Merge target individuals with ad widgets

AdOpt fuses data from different companies (advertisers and publishers) with background information (direct marketing databases) to provide a uniquely rich and sophisticated take on ad selection and placement (Ref L).

The input data steam of specific subscribers and advertiser customers (Ref L) is used to pick up the appropriate advertising widget (Ref F) and the ad template is then populated with the appropriate data from the input data stream.

The Platform integrates with existing Digital Media industry Ad Servers and enables a large subscriber base to be accessed. The system serves advert widgets in significantly less than 1 second, no matter where the subscriber is accessing the media and from what device.

The ads will be served into digital publications (Ref N) and/or websites (Ref 0).

Ad content will be rendered on pages via a Javascript client library.

When an ad is served a record will be maintained that will include:

Transaction ID

Timestamp (GMT, naturally)

Unique tracking marker. Tracking a user within a site and potentially across sites.

Action. Impression or click through.

Advertiser. The advertiser slug.

Publisher. The publication slug.

Publisher customer ID. If any.

Advertiser customer ID. If any.

Rule. The rule that fired.

Firing strength

Price (for advertiser)

Cost (to Red Fox Media for publication slot and pay-for data use).

This record is recorded on the Activity Database (Ref R) and fed back in to the Data Repository (Ref I) to allow it to be input to further modelling (Ref L).

N—Digital Publishing Platform

Digital publishing platforms that are capable of accepting targeted advertisements from the Probabilistic Entity View modelling pick up the targeted ad produced in the Presentation Layer (Ref M) and present it from the ad server into the reader's publication.

Depending on the design of the digital publication a new ad could be served to the reader each time they look at the publication (and are online) and/or each time the publication is downloaded by the reader into their digital device.

O—Websites

Websites that are capable of accepting targeted advertisements from the Probabilistic Entity View modelling will pick up the targeted ad produced in the Presentation Layer (Ref M) and present it from the ad server into the website. Depending on the design of the website a new ad could be served to the reader each time they look at the site. Note: This does not make any use of cookie based solutions and no cookies are required to support this design.

P—Named Target Ads, Profiled Target Ads, Generic Ads

Based upon the results of the Presentation Layer (Ref M) the ads served to selected publication reader (Digital publication or website) are: Highly personalised (Named Targets) as a result of a very string firing strength (Ref E) and a high match threshold being achieved; Targeted but more general (Profiled Target) as a result of a medium firing strength (Ref E) and a high to medium match threshold being achieved; Generic where there is a low firing strength (Ref E) or low match threshold.

No ad served where the firing strength is very low or the advertisers budget has been used up or there is a low match threshold.

Q—Click

Where an ad has been served that has a call to action on it (reader to select to click on to a link such as website or social media) then any execution of the call to action is recorded and logged into the Activity database (Ref R). Such activity is the fed back into the Data Repository (Ref I) for incorporation into further modelling activities (Ref M).

R—Activity Data

This repository is used to store all modelling results (Ref L), ads served (Ref M) and call to action activity (Ref Q). The repository feeds activity data back in to the Data Repository (Ref I) for subsequent analysis via the modelling (Ref L). It also provide the source of Management Information for onward reporting (Ref S).

S—Reporting

The analysis of the activity levels in the PEV sourced via the Activity Data (Ref R) to provide the operational control reporting (Ref T) associated with the PEV performance and onward reporting into the online portals (Ref W and X).

T—Operations

Operational monitoring of the PEV performance and service levels.

Extraction of data to serve up into the Publisher and Advertiser online portals (Ref W and X) to allow them to see activities levels and also view billing and billing history.

U—Invoicing

Data sourced from the Activity Data (Ref R) to bill for PEV activities.

V—Reporting

Reports of activity levels, results of ads placed and other MI required by the advertisers or publishers.

Support Functions

The following system administration capabilities are deployed to support the functional processing.

Comms links—Support dynamic content (animations etc.)

Solution Stack—Linux (Ubuntu LTS (potential).

Java 6 (potential): supports scalable systems

Jetty 7 (potential): server for Java web-apps.

Hadoop/HBase (potential): for scalable data processing. HBase is a distributed database for Hadoop. It trades the features of a relational database for scalable data-handling & processing.

Nginx (potential): High-performance reverse proxy and static/ad content server

EHCache (potential): Distributed caching layer

PostgreSQL/Hibernate (potential): for relational aspects of the system e.g. user account management

Velocity (potential): secure, high-performance template engine

The solution stack proposed may have one or two components changed depending on the results of performance management.

Ad Servers—Ad servers to serve high volumes at sub second

Ad servers are the front-end web-servers that select and deliver the ad content itself.

These must be highly-responsive.

Design/features:

Ad rules stored in memory (but persisted to disk). This is scalable to millions of rules and offers the highest possible performance.

Ad rule evaluation and constraint checks

Ad rotation algorithm based on exposure frequency and budget.

Detailed transaction history (requiring distributed unique tracking markers “UTM”s)

Ad display logs

Click logs

Ad Server integration—The platform provides a new approach to ad Serving. Currently all Ad Servers have their own basis for segmentation built in and are based on very wide demographics such as gender, age and income. Hence the existing Ad Server framework is designed to perpetuate the existing Volume model as opposed to one to one direct communication.

The claimed system integrates with existing Ad Servers for each Publisher. There is no general solution to this problem. Specific plugins for specific publishers are deployed.

Load Balancing—The PEV contains a profile for every publisher, advertiser client and will grow very rapidly.

The matching algorithm within the modelling (Ref L) effectively requires comparing every record with every other record in the store. If there are a million records this is a trillion comparisons. And it is not unreasonable to expect to have hundreds of millions of rows—over a quadrillion comparisons.

These computations can be done “off-line” i.e. they are not on the ad serve hotpath. However the sheer scale of this challenge, implies that the system must be designed from the outset to accommodate this requirement.

The Hadoop distributed data processing library as a distributed computing library will be used. Hadoop allows Applicant to run the matching fusion algorithm across a cluster of machines and servers. Unlike traditional batch processing systems, Hadoop is designed to scale simply by adding more machines.

AD Content selection—The content selection algorithm is the main bottleneck in the ad serve pipeline. The claimedsystem architecture is strongly conditioned by the need to keep selection latency low, whilst serving hundreds of requests per second.

In order to meet these requirements, batch process is used and the results store it directly in the PEV for use by the Presentation Layer (Ref M). The advertising rules/strategies and campaign information are stored in memory on each front-end server. Logging and audit is (effectively) deferred until the ad is ready to go.

In this way disk IO on the ad server hotpath will be kept to a minimum—allowing performance targets to be achieved.

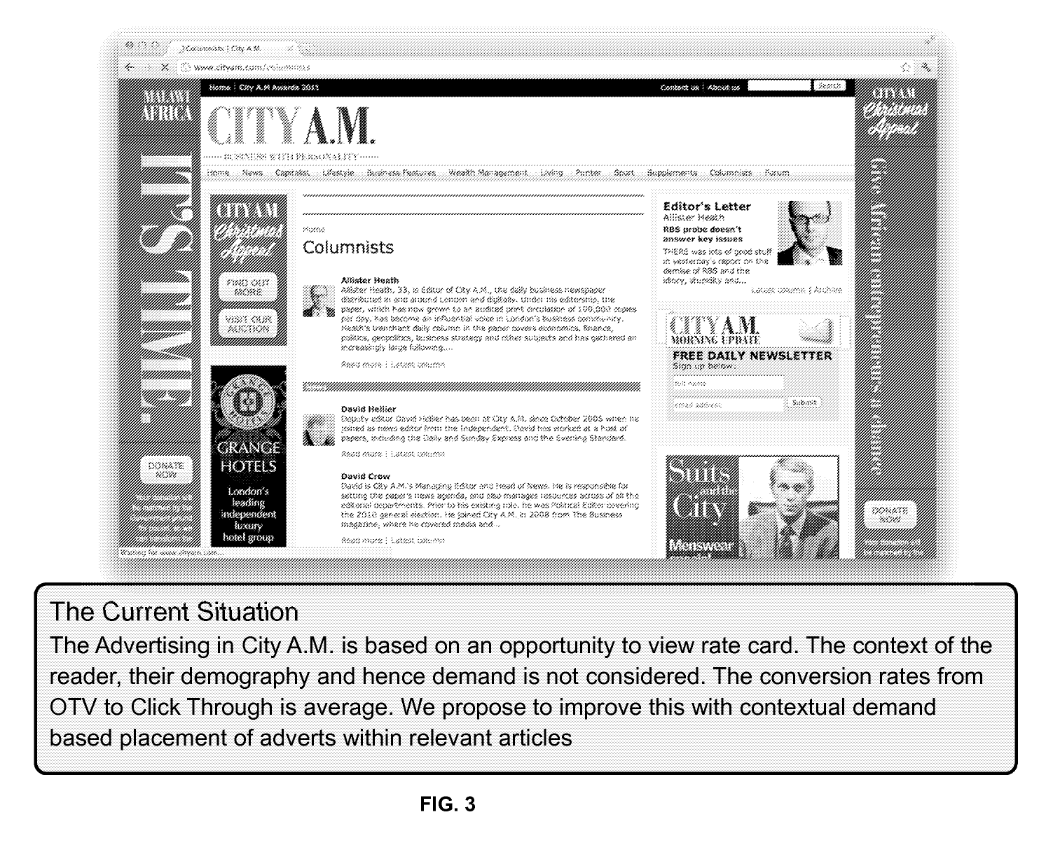

FIG. 3 shows advertising displayed in accordance with the prior art, on a “CITY A.M. webpage. The advertising shown in this figure is based on an “opportunity to view” rate card. The conversion rates from OTV to click-through is average. The claimed invention improves upon this with contextual demand-based placement of adverts within relevant articles.

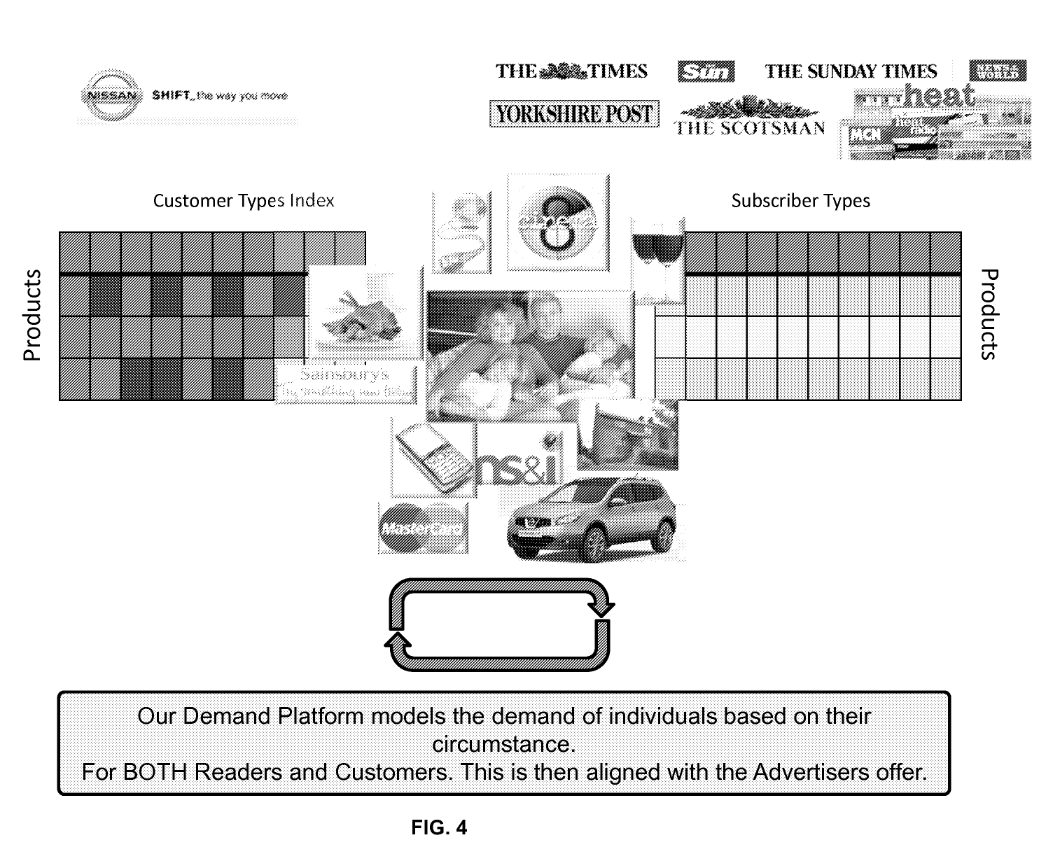

FIG. 4 shows a model of the demand platform model of the claimed invention, as described herein.

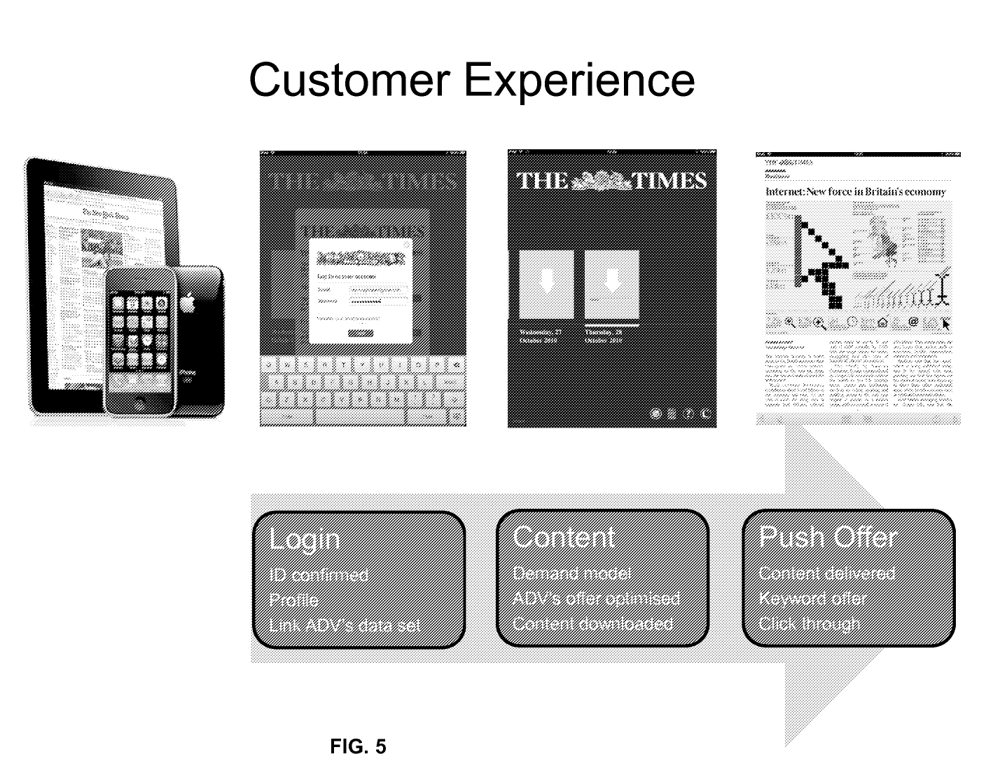

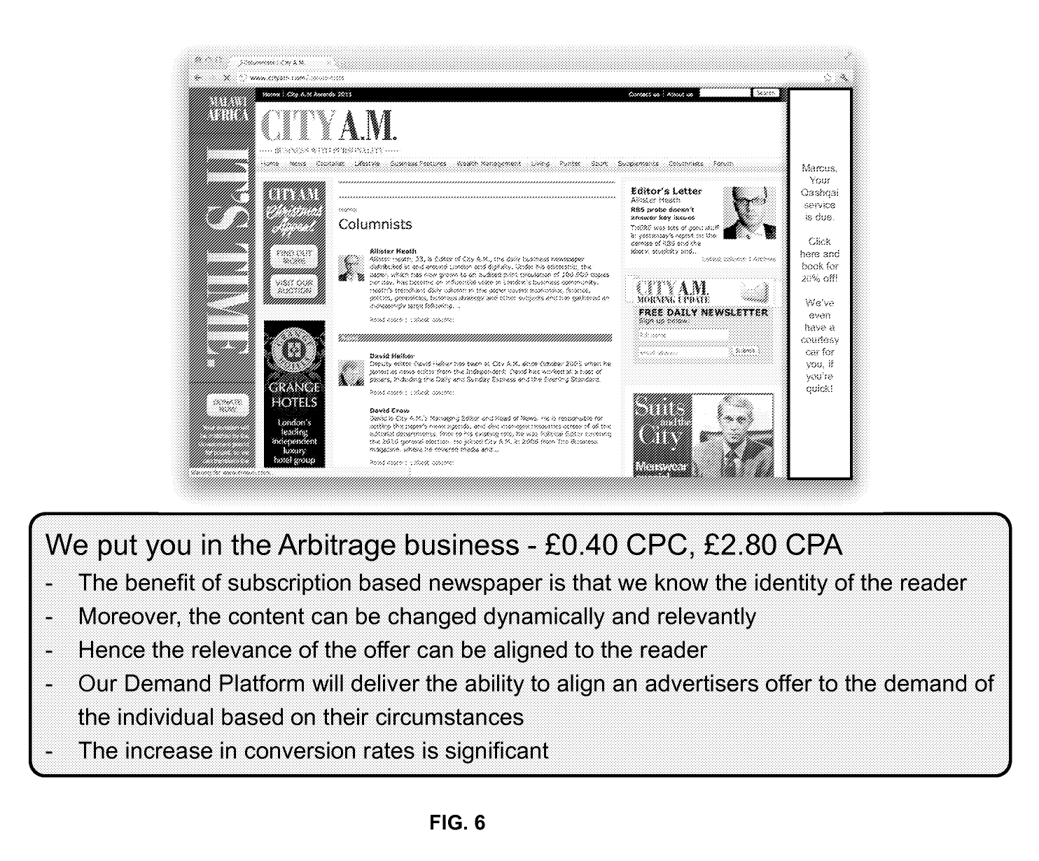

FIG. 5 shows the login, content display, and push offers according to the process of the claimed invention. FIG. 6 shows an example of a result of using the claimed invention. As can be seen along the right side of the web page, customized advertising is presented to the subscriber.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known media for use with a data processing system, such as a diskette, or hard drive, or CD ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

1. A method for optimizing advertising directed to a consumer of digital content consuming the digital content via a workstation, comprising:
establishing a relationship between a trusted third party advertisers;
establishing a relationship between the trusted third party and digital content providers;
identifying any relationships already established between said consumer and any of said trusted third party advertisers;
identifying any relationships already established between said consumer and any of said digital content providers;
identifying any demographic information about individuals who have established relationships with the trusted third party advertisers and/or the digital content providers; and
targeting advertising to said consumer based on said identified relationships and said identified demographic information.
